(19) United States
(12) Patent Application Publication
(10) Pub. No.: US 2026/0340853 A1
(43) Pub. Date: Oct. 29, 2026

(54) VEHICULAR TRAILERING ASSIST SYSTEM WITH TRAILER BEAM LENGTH ESTIMATION USING SIDE SENSOR

(71) Applicant: Magna Electronics Inc., Auburn Hills, MI (US)

(72) Inventors: Jyothi P. Gali, Rochester Hills, MI (US); Prasanna Ananthakrishnan, Tamilnadu (IN); Sharad Benakatti, Bangalore (IN)

(21) Appl. No.: 19/656,263

(22) Filed: Apr. 23, 2026

Related U.S. Application Data
(60) Provisional application No. 63/795,666, filed on Apr. 28, 2025.

(51) Int. Cl. G06T 7/60; B60D 1/30; B60T 8/171; B62D 15/02; G06T 7/13; G06T 7/73

(52) U.S. Cl. CPC G06T 7/60; B60T 8/171; B62D 15/025; G06T 7/13; G06T 7/73; B60D 1/30; B60T 2230/06; B60T 2230/08; B60T 2250/00; G06T 2207/30252

(57) ABSTRACT

A vehicular trailering assist system includes a camera disposed at a side of a vehicle equipped with the trailering assist system and viewing exterior of the vehicle. The vehicular trailering assist system, responsive to processing by the image processor of image data captured by the camera, determines image coordinates corresponding to a ground contact point of a trailer tire of a trailer hitched to the vehicle via a hitch. The vehicular trailering assist system transforms the image coordinates into world coordinates. The vehicular trailering assist system determines a trailer beam length of the trailer based on a geometric relationship between the ground contact point of the trailer tire in the world coordinates, a position of the hitch in the world coordinates, and a current trailer angle between a longitudinal axis of the vehicle and a longitudinal axis of the trailer.

### CROSS REFERENCE TO RELATED APPLICATION

The present application claims the filing benefits of U.S. provisional application Ser. No. 63/795,666, filed Apr. 28, 2025, which is hereby incorporated herein by reference in its entirety.

### TECHNICAL FIELD

The present invention relates generally to a vehicle vision system for a vehicle and, more particularly, to a vehicle vision system that utilizes one or more cameras at a vehicle.

### BACKGROUND

Use of imaging sensors in vehicular trailer assist systems is common and known. Examples of such known systems are described in U.S. Pat. Nos. 9,446,713 and 9,085,261, which are hereby incorporated herein by reference in their entireties.

### SUMMARY

A vehicular trailering assist system includes a camera disposed at a side of a vehicle equipped with the trailering assist system and viewing exterior of the vehicle. The camera captures image data. The system includes an electronic control unit (ECU) that includes electronic circuitry and associated software. The electronic circuitry of the ECU includes an image processor for processing image data captured by the camera. The vehicular trailering assist system, responsive to processing by the image processor of image data captured by the camera, determines image coordinates corresponding to a ground contact point of a trailer tire of a trailer hitched to the vehicle via a hitch. The vehicular trailering assist system transforms the image coordinates into world coordinates. The vehicular trailering assist system determines a trailer beam length of the trailer based on a geometric relationship between the ground contact point of the trailer tire in the world coordinates, a position of the hitch in the world coordinates, and a current trailer angle between a longitudinal axis of the vehicle and a longitudinal axis of the trailer.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a trailering assist system hitched to a trailer;

FIG. 2 is schematic view of a vehicle hitched to a trailer;

FIG. 3 is a block diagram of a trailering assist system;

FIG. 4 is an image captured by a camera disposed at a side of a vehicle that includes a tire of a trailer;

FIG. 5 is an image of FIG. 4 after an edge detection algorithm has been applied; and

FIG. 6 is a schematic view of a vehicle and geometric positions of a trailer hitched to the vehicle.

### DETAILED DESCRIPTION

Trailer assistance features, such as automated path planning, automated reversing assistance, trailer sway mitigation, and blind spot monitoring, utilize geometric parameters of a trailer. Such geometric parameters include a trailer beam length (i.e., a distance measured from a hitch point to a trailer axle center). Manual measurement of the trailer beam length and manual entry into a vehicle system may be cumbersome for a user. In some examples, manual entry introduces input errors. Alternatively, kinematic-based estimation methods utilize vehicle movement data, but such methods occasionally suffer from relatively high estimation errors due to sensor drift or uneven terrain. Exemplary implementations herein provide a vision-based approach to estimate the trailer beam length. The vision-based approach utilizes image data to determine geometric properties, aiming to improve accuracy without manual intervention.

Exemplary implementations herein utilize side-mounted cameras of a towing vehicle (e.g., cameras mounted at one or more side mirrors of the towing vehicle, cameras mounted at vehicle fenders, or cameras mounted at vehicle pillars) to visually detect features of the trailer. In some examples, the visually detected features include trailer tires, trailer fenders, or trailer marker lights. The exemplary implementations utilize visual information associated with the detected features along with vehicle and hitch parameters to determine the trailer beam length geometrically. The vehicle and hitch parameters optionally include a vehicle wheelbase, a hitch length, and a hitch height. The trailer beam length estimation may occur during a calibration process. The calibration process generates a resulting beam length. A memory device may store the resulting beam length and associate the resulting beam length with a particular trailer profile. A trailering assist system may retrieve the stored value and use the stored value for path planning, collision avoidance, or other functions in response to detecting or selecting a specific trailer associated with the particular trailer profile.

A vehicle and trailer maneuvering system, a trailering assist system, and/or a driving assist system operates to capture images exterior of the vehicle and the trailer being towed by the vehicle. The trailering assist system may process captured image data to determine the trailer beam length. The trailering assist system includes an image processor or an image processing system operable to receive the image data from one or more cameras. The image processor may comprise a central processing unit (CPU), a graphics processing unit (GPU), a digital signal processor (DSP), a field-programmable gate array (FPGA), or an application-specific integrated circuit (ASIC). The image processor may provide an output to a display device for displaying images representative of the captured image data. The display device may comprise a touchscreen interface, a head-up display (HUD), an instrument cluster display, or an interior rearview mirror display. Optionally, the trailering assist system may provide a rearview display, a top-down display, a bird's eye display, or a surround view display. In some examples, the display device provides augmented reality overlays, dynamic predictive guidelines, and trailer articulation angle indicators based on the determined trailer beam length.

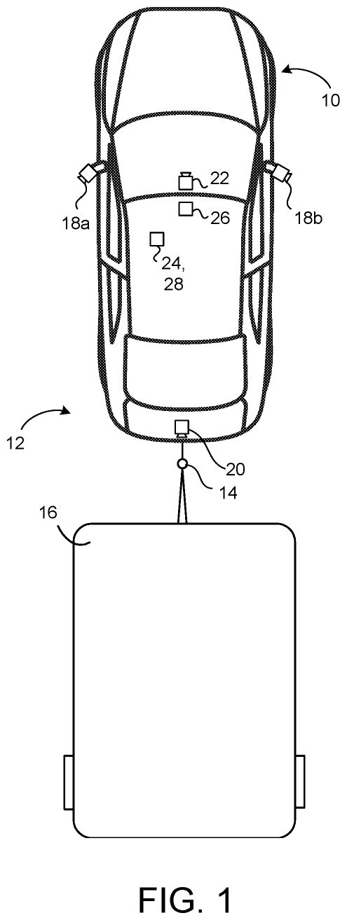

Referring now to the drawings and the illustrative embodiments depicted therein, a vehicle 10 includes a trailering assist system 12 operable to assist in backing up or reversing with a hitched trailer via, for example, a hitch 14. The trailering assist system 12 may maneuver the vehicle 10 and a trailer 16 toward a desired or selected location. The trailering assist system 12 includes at least one exterior viewing vehicle-based imaging sensor or camera, such as a sideward/rearward viewing camera 18a, 18b at respective sides of the vehicle 10. The trailering assist system 12 may optionally include other exterior viewing imaging sensors or cameras, such as a rearward viewing imaging sensor or camera 20, capturing image data representative of a scene exterior of the vehicle 10 (FIG. 1). Optionally, a forward viewing camera 22 may be disposed at a windshield of the vehicle 10 and view through the windshield and forward of the vehicle 10. The forward viewing camera 22 may support a machine vision system for traffic sign recognition, headlamp control, pedestrian detection, collision avoidance, or lane marker detection. The trailering assist system 12 includes a control or electronic control unit (ECU) 24 or processor operable to process image data captured by the respective cameras 18a, 18b, 20. The ECU 24 may detect objects and provide displayed images at a display device 26 for viewing by a driver of the vehicle 10. The ECU 24 and the display device 26 may be incorporated in an interior rearview mirror assembly of the vehicle 10, or the ECU 24 and the display device 26 may be disposed elsewhere at the vehicle 10. The vehicle 10 includes a memory 28 in communication with the ECU 24 for storing trailer profiles, calibration data, and geometrical equations. A data transfer or signal communication from the respective cameras 18a, 18b, 20 to the ECU 24 may comprise a communication link, such as a vehicle network bus. The vehicle network bus may comprise a Controller Area Network (CAN) bus, a Local Interconnect Network (LIN) bus, an Ethernet connection, or a FlexRay communication path.

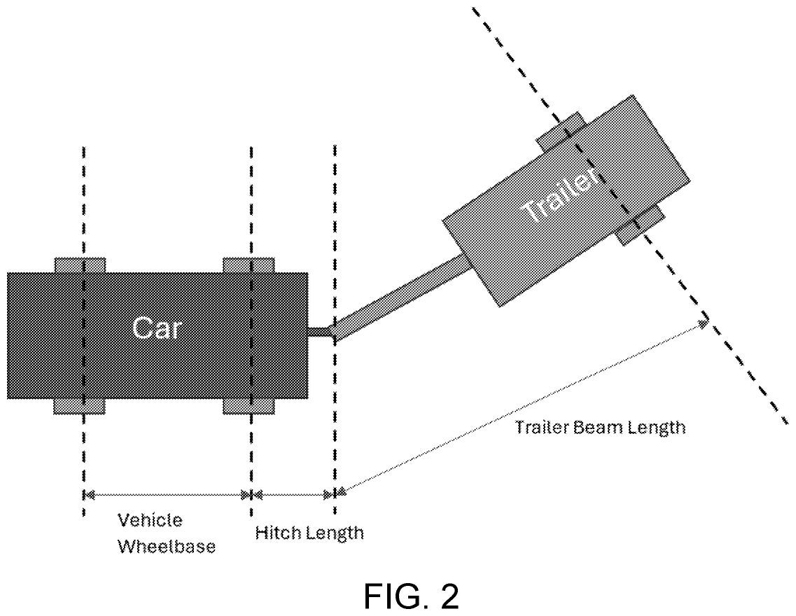

FIG. 2 provides a plan view that includes the vehicle 10 coupled to the trailer 16. The plan view illustrates dimensions relevant to the trailering assist system 12, including a vehicle wheelbase (measured from a vehicle front axle to a vehicle rear axle), a hitch length (measured from the vehicle rear axle to a hitch articulation point), and a trailer beam length (measured from the hitch articulation point to a trailer axle). In some examples, accurate measurement of the dimensions facilitates dynamic modeling of the vehicle 10 and the trailer 16 by the ECU 24. The hitch articulation point corresponds to a pivoting connection between the vehicle 10 and the trailer 16, such as a ball mount and coupler assembly. The trailering assist system 12 may utilize sensor data from suspension sensors or wheel speed sensors to verify distances associated with the vehicle wheelbase or the hitch length.

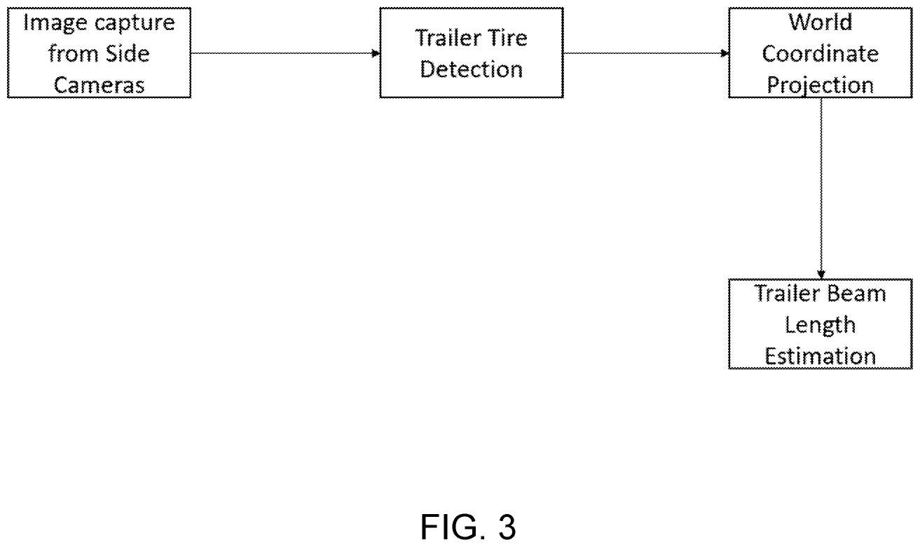

Referring now to FIG. 3, the trailering assist system 12 utilizes side cameras (e.g., the sideward/rearward viewing cameras 18a, 18b of FIG. 1) to capture images of the attached trailer 16 during specific maneuvers, such as part of a calibration process. FIG. 3 includes a block diagram of a trailer beam length estimation process of the trailering assist system 12. The block diagram includes an image capture from side cameras step providing input to a trailer tire detection step. Output from the trailer tire detection step is processed by a world coordinate projection step. The world coordinate projection step provides projected coordinates to a trailer beam length estimation step. The trailer beam length estimation step operates to determine the trailer beam length. In some implementations, the image capture from side cameras step involves capturing video streams or high-resolution still frames. The trailer tire detection step may utilize machine learning models, convolutional neural networks (CNNs), semantic segmentation algorithms, or template matching to isolate visual features of the trailer 16.

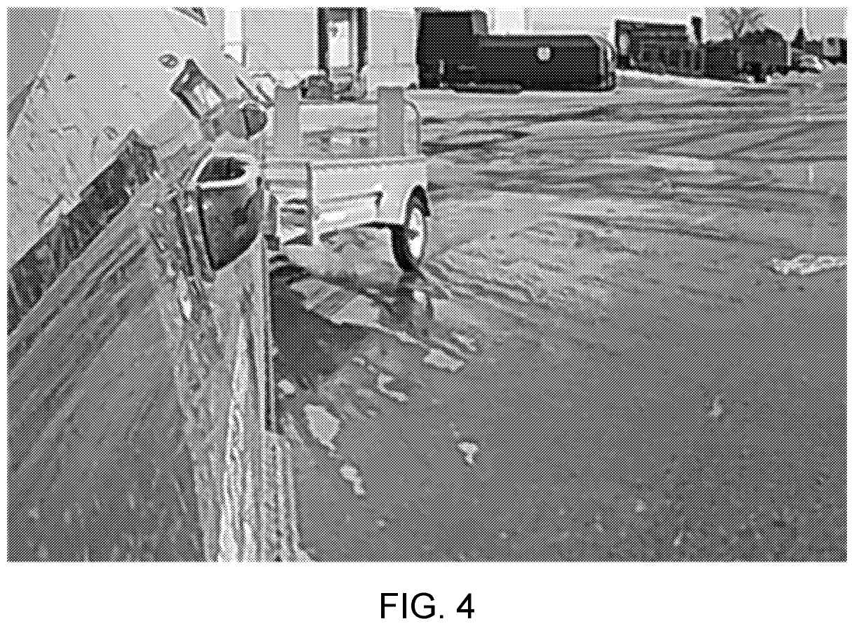

The trailer beam length determination may occur during a calibration phase. During the calibration phase, the vehicle 10 and the attached trailer 16 maneuver to articulate the trailer 16 relative to the vehicle 10. For example, the sideward/rearward viewing cameras 18a, 18b capture images in response to a trailer angle exceeding a predetermined threshold. The trailer angle is defined as an angle between a longitudinal axis of the vehicle and a longitudinal axis of the trailer. The predetermined threshold is based on a condition where a trailer tire on a corresponding side of the trailer 16 becomes clearly visible to the corresponding sideward/rearward viewing camera 18a, 18b (FIG. 4). The ECU 24 selects the appropriate sideward/rearward viewing camera 18a, 18b based on a direction of articulation of the trailer 16 relative to the vehicle 10 (i.e., a turning direction of the vehicle 10). In various examples, the predetermined threshold comprises 15 degrees, 25 degrees, or 30 degrees. Optionally, the predetermined threshold dynamically adjusts based on a field of view of the sideward/rearward viewing cameras 18a, 18b. The ECU 24 may determine the trailer angle utilizing a rotary encoder at the hitch 14, image analysis from the rearward viewing camera 20, or a combination of steering angle sensors and yaw rate sensors.

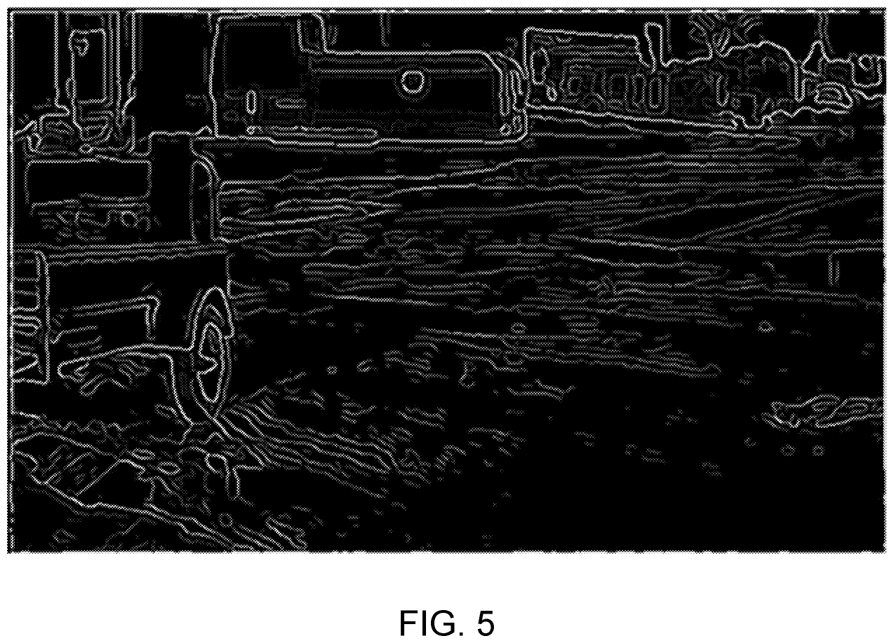

In response to capturing a captured image, the ECU 24 may apply image processing techniques. For example, the ECU 24 may apply an edge detection algorithm, such as a Canny edge detector, a Sobel operator, or a Prewitt operator, to the captured image or to a region of the captured image containing the trailer tire, to identify distinct edges (FIG. 5). The distinct edges may include edges associated with the trailer tire. From processed image data, the ECU 24 may identify image coordinates corresponding to a ground contact point where the detected trailer tire contacts a ground surface. The ground contact point may be identified by calculating an intersection between a perimeter edge of the trailer tire and a horizontal line representing the ground surface. In some examples, the ECU 24 applies morphological operations or thresholding filters to enhance the distinct edges prior to identifying the image coordinates.

Based on identification of the ground contact point in the image coordinates, the image coordinates may be transformed into world coordinates. The ECU 24 may achieve the transformation using a camera projection matrix associated with the sideward/rearward viewing camera 18a, 18b capturing the captured image. The camera projection matrix may encapsulate intrinsic parameters and extrinsic parameters of the respective sideward/rearward viewing camera 18a, 18b. The camera projection matrix allows for mapping of points from a 2D image plane to a 3D world space. The 3D world space may comprise a coordinate system fixed to the vehicle 10 or the ground surface. In exemplary implementations, the intrinsic parameters include a focal length, an optical center, and lens distortion coefficients of the respective sideward/rearward viewing camera 18a, 18b. The extrinsic parameters may include camera rotation variables and camera translation variables mapping camera placement relative to the coordinate system fixed to the vehicle 10. The coordinate system fixed to the vehicle 10 may comprise a Cartesian coordinate system originating at a center point of the vehicle rear axle.

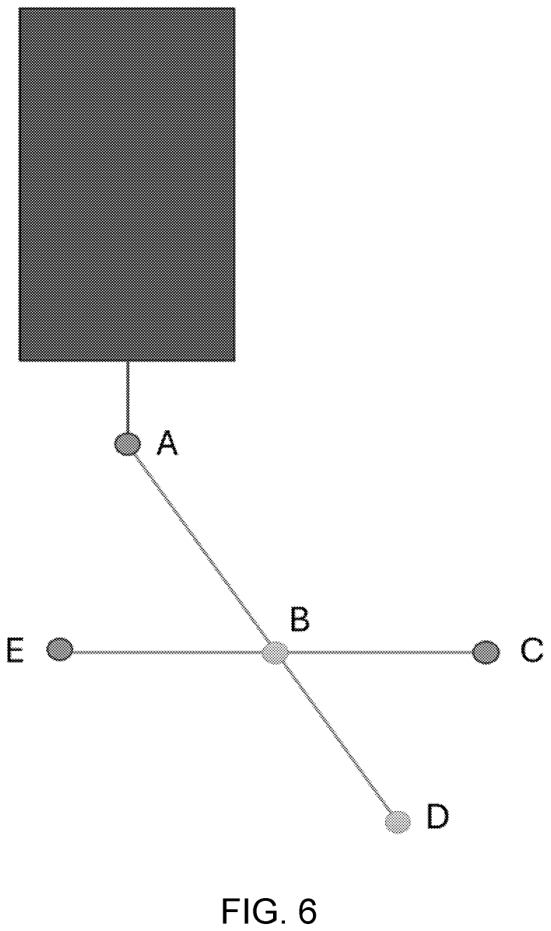

Referring now to FIG. 6, based on determining a position of the trailer tire in the world coordinates and based on a position of the hitch 14, the ECU 24 may determine or estimate the trailer beam length utilizing geometrical equations. The ECU 24 may determine the position of the hitch 14 utilizing image processing or sensor data analysis. For example, the ECU 24 may utilize data from the rearward viewing camera 20 and the trailer angle to determine the position of the hitch 14. FIG. 6 illustrates geometric points and relationships used in the determination. A point A represents the position of the hitch 14 in the world coordinates. A point C represents the ground contact point of the detected trailer tire in the world coordinates. A line segment AD represents a trailer centerline defined by the point A and the trailer angle. The ECU 24 may place an assumed point D along the line segment AD based on an assumed or default trailer length. In some examples, the assumed or default trailer length corresponds to a maximum legal towing limit or an average trailer dimension. A point E represents an assumed position for an opposite trailer tire related geometrically to the point C. The point C and the point E define a trailer axle line CE. A point B represents an intersection point of the trailer centerline (represented by the line segment AD) and the trailer axle line CE. The ECU 24 determines a location of the point B accurately, wherein the trailer beam length corresponds to a distance between the hitch 14 (represented by the point A) and an axle intersection (represented by the point B).

The ECU 24 may utilize an iterative algorithm to refine a geometric configuration and determine the location of the point B, thereby determining the trailer beam length. The iterative algorithm may initialize the trailer beam length to a default value (e.g., two meters in floating point representation) and set a status flag to a false state. The ECU 24 establishes a starting geometric setup utilizing the point A, the point C, the trailer angle (defining a direction of the line segment AD), and optionally assumed starting positions for the point D and the point E. The iterative algorithm iteratively adjusts geometry. For example, the ECU 24 iteratively adjusts an orientation of the trailer axle line CE by rotating the point E around the point C in increments. In some examples, the increments comprise rotations of 0.5 degrees, 0.1 degrees, or 1.0 degrees within an established boundary range. In each iteration step, the ECU 24 determines the point B representing the intersection point of the line segment AD and the trailer axle line CE. The ECU 24 determines a geometric condition based on the refined geometric configuration. For example, the ECU 24 determines an angle based on the point A, the point B, and the point C. The ECU 24 verifies whether an absolute value of the angle falls within a defined range. In exemplary implementations, the defined range comprises a range between 89.5 degrees to 90.5 degrees, or between 89.0 degrees to 91.0 degrees to account for sensor noise or uneven ground surfaces. The geometric condition identifies the geometric configuration in which the trailer axle line CE has an expected orientation relative to the trailer centerline. The expected orientation may correspond to a perpendicular relationship or other expected geometric property. For example, the line segment AD may be perpendicular to the trailer axle line CE.

In response to the geometric condition being met, the ECU 24 sets the status flag to a true state, terminates the iterative algorithm, and determines the trailer beam length as a Euclidean distance between the point A and the point B. The ECU 24 may utilize a distance formula (e.g., Euclidean distance=√((x₂−x₁)²+(y₂−y₁)²)) to determine the Euclidean distance. In the distance formula, x1 and y1 represent coordinates of the point A, and x² and y₂ represent coordinates of the point B applied to the world coordinates. The trailering assist system 12 may apply filtering or smoothing algorithms to the Euclidean distance to generate a stable output. In response to the iterative algorithm completing without satisfying the geometric condition, the ECU 24 may retain the trailer beam length at the initialized default value. In further examples, in response to failing to satisfy the geometric condition, the trailering assist system 12 generates an error notification at the display device 26, prompts a user for manual input, or records a diagnostic code at the memory 28.

The ECU 24 may store the determined trailer beam length at a non-volatile memory (NVM) of the vehicle 10. The memory 28 may comprise the NVM. The trailering assist system 12 associates the determined trailer beam length with a specific trailer profile representing the trailer 16 being calibrated. In response to the trailering assist system 12 recognizing or selecting the trailer 16, the ECU 24 retrieves stored trailer beam length data from the NVM. Vehicle systems utilize the retrieved trailer beam length data to execute trailer assist features, such as accurate path planning, automated steering control, electronic braking distribution, and sway mitigation. Furthermore, the trailering assist system 12 may recognize or validate an identity of an attached trailer based on corresponding physical dimensions. For example, the ECU 24 compares newly calculated physical dimensions to historical dimensions stored in the specific trailer profile to detect a mismatch or confirm the identity of the trailer 16. In some implementations, the trailering assist system 12 supplements visual recognition with radio frequency identification (RFID) tags, Bluetooth low energy (BLE) beacons, or user interface selections to ensure robust validation.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or U.S. Pat. No. 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of the trailering assist systems or trailer angle detection systems or trailer hitch assist systems described in U.S. Pat. Nos. 11,787,339; 11,613,210; 10,755,110; 10,733,757; 10,706,291; 10,638,025; 10,586,119; 10,552,976; 10,532,698; 10,160,382; 10,086,870; 9,558,409; 9,446,713; 9,085,261 and/or 6,690,268, and/or U.S. Publication Nos. US-2022-0028111; US-2022-0027644; US-2022-0024391; US-2021-0170947; US-2021-0170820; US-2021-0078634; US-2021-0053572; US-2020-0406967; US-2020-0361397; US-2020-0356788; US-2020-0334475; US-2020-0017143; US-2019-0347825; US-2019-0118860; US-2019-0064831; US-2018-0276838; US-2018-0215382; US-2017-0254873; US-2017-0217372 and/or US-2015-0002670, and/or International Publication No. WO 2021/0127693, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular trailering assist system, the vehicular trailering assist system comprising:
a camera disposed at a side of a vehicle equipped with the trailering assist system and viewing exterior of the vehicle, the camera capturing image data;
an electronic control unit (ECU) comprising electronic circuitry and associated software;
wherein the electronic circuitry of the ECU comprises an image processor for processing image data captured by the camera;
wherein the vehicular trailering assist system, responsive to processing by the image processor of image data captured by the camera, determines image coordinates corresponding to a ground contact point of a trailer tire of a trailer hitched to the vehicle via a hitch;
wherein the vehicular trailering assist system transforms the image coordinates into world coordinates; and
wherein the vehicular trailering assist system determines a trailer beam length of the trailer based on a geometric relationship between the ground contact point of the trailer tire in the world coordinates, a position of the hitch in the world coordinates, and a current trailer angle between a longitudinal axis of the vehicle and a longitudinal axis of the trailer.

2. The vehicular trailering assist system of claim 1, wherein the vehicular trailering assist system determines the image coordinates corresponding to the ground contact point of the trailer tire during a trailer calibration phase.

3. The vehicular trailering assist system of claim 2, wherein the trailer calibration phase comprises maneuvering the vehicle until the current trailer angle exceeds a predetermined threshold.

4. The vehicular trailering assist system of claim 3, wherein the predetermined threshold comprises 25 degrees.

5. The vehicular trailering assist system of claim 1, wherein the vehicular trailering assist system determines the image coordinates corresponding to the ground contact point of the trailer tire utilizing an edge detection algorithm.

6. The vehicular trailering assist system of claim 5, wherein the edge detection algorithm comprises a Canny edge detector, a Sobel operator, or a Prewitt operator.

7. The vehicular trailering assist system of claim 1, wherein the vehicular trailering assist system transforms the image coordinates into the world coordinates utilizing a camera projection matrix encapsulating intrinsic parameters of the camera and extrinsic parameters of the camera.

8. The vehicular trailering assist system of claim 1, wherein the vehicular trailering assist system utilizes an iterative algorithm to define a trailer axle line extending from the ground contact point of the trailer tire in the world coordinates and to identify an intersection point between the trailer axle line and the longitudinal axis of the trailer.

9. The vehicular trailering assist system of claim 8, wherein the vehicular trailering assist system determines the trailer beam length as a Euclidean distance between the position of the hitch in the world coordinates and the intersection point.

10. The vehicular trailering assist system of claim 1, wherein the vehicular trailering assist system stores the trailer beam length at a non-volatile memory, associates the trailer beam length with a specific trailer profile, and utilizes the trailer beam length to execute a trailer assist feature comprising automated path planning, automated steering control, electronic braking distribution, or sway mitigation.

11. A method comprising:
determining, responsive to processing by an image processor of image data captured by a camera disposed at a side of a vehicle, image coordinates corresponding to a ground contact point of a trailer tire of a trailer hitched to the vehicle via a hitch;
transforming the image coordinates into world coordinates; and
determining a trailer beam length of the trailer based on a geometric relationship between the ground contact point of the trailer tire in the world coordinates, a position of the hitch in the world coordinates, and a current trailer angle between a longitudinal axis of the vehicle and a longitudinal axis of the trailer.

12. The method of claim 11, wherein determining the image coordinates corresponding to the ground contact point of the trailer tire is during a trailer calibration phase.

13. The method of claim 12, wherein the trailer calibration phase comprises maneuvering the vehicle until the current trailer angle exceeds a predetermined threshold.

14. The method of claim 13, wherein the predetermined threshold comprises 25 degrees.

15. The method of claim 11, wherein determining the image coordinates corresponding to the ground contact point of the trailer tire comprises utilizing an edge detection algorithm.

16. The method of claim 15, wherein the edge detection algorithm comprises a Canny edge detector, a Sobel operator, or a Prewitt operator.

17. The method of claim 11, wherein transforming the image coordinates into the world coordinates comprises utilizing a camera projection matrix encapsulating intrinsic parameters of the camera and extrinsic parameters of the camera.

18. The method of claim 11, further comprising:
utilizing an iterative algorithm to define a trailer axle line extending from the ground contact point of the trailer tire in the world coordinates; and
identifying an intersection point between the trailer axle line and the longitudinal axis of the trailer.

19. The method of claim 18, wherein determining the trailer beam length comprises determining the trailer beam length as a Euclidean distance between the position of the hitch in the world coordinates and the intersection point.

20. The method of claim 11, further comprising:
storing the trailer beam length at a non-volatile memory;
associating the trailer beam length with a specific trailer profile; and
utilizing the trailer beam length to execute a trailer assist feature comprising automated path planning, automated steering control, electronic braking distribution, or sway mitigation.
